(19) United States
(12) Patent Application Publication
(10) Pub. No.: US 2026/0242882 A1
(43) Pub. Date: Aug. 20, 2026

(54) SURFACE TREATMENT AGENT FOR LEATHER AND LEATHER SURFACE-TREATED USING THE SAME

(71) Applicant: NICCA CHEMICAL CO., LTD., Fukui-shi, Fukui (JP)

(72) Inventors: Yusuke SAITO, Fukui-shi (JP); Kuniaki KONDO, Fukui-shi (JP); Masakazu NISHINO, Fukui-shi (JP)

(73) Assignee: NICCA CHEMICAL CO., LTD., Fukui-shi, Fukui (JP)

(21) Appl. No.: 18/878,974

(22) PCT Filed: Jun. 29, 2022
(86) PCT No.: PCT/JP2022/026081

§ 371 Date: Dec. 26, 2024

(51) Int. Cl. C14C 11/00; B32B 5/18; B32B 9/02; B32B 9/04; C09D 7/63; C09D 7/65; C09D 133/04; C09D 175/04

(52) U.S. Cl. CPC C14C 11/006; B32B 5/18; B32B 9/025; B32B 9/046; C09D 7/63; C09D 7/65; C09D 133/04; C09D 175/04; C14C 11/003; B32B 2266/0278; B32B 2307/546

(57) ABSTRACT

A surface treatment agent for leather contains a resin capable of forming a resin layer on a surface of a leather base material, and a compound having two or more active hydrogens per molecule.

### TECHNICAL FIELD

The present invention relates to a surface treatment agent for leather and a leather surface-treated using the same.

### BACKGROUND ART

Lathers represented by synthetic leathers each having a skin layer made of a polyurethane resin (PU skin layer), polyvinyl chloride (PVC) leathers, and the like are laminated to flexible polyurethane foams to form cushioning composite materials, which are used in a wide range of fields such as interior materials for automobiles and furniture because of their pleasant feel. Such cushioning composite materials are manufactured by a so-called flame lamination method, in which the surface of a flexible polyurethane foam is burned and melted by flame or other means, and a synthetic leather or the like is laminated to the melted surface. However, the cushioning composite materials manufactured by the flame lamination method have a problem of yellowing of the leather surfaces. Since dark-colored synthetic leathers and the like such as black and gray leathers were used heretofore, discoloration of the leather surfaces was unnoticeable and was not a major problem. However, in recent years, light-colored synthetic leathers and the like such as white and beige leathers have come to be used more often, so discoloration of the leather surfaces have been more noticeable and become a major problem. For this reason, there is a demand for a method capable of suppressing yellowing of leather surfaces in cushioning composite materials manufactured by the flame lamination method.

Known methods for suppressing yellowing of a flexible polyurethane foam itself include, for example, a method of blending a foaming raw material containing a polyol, an aromatic polyisocyanate, a foaming agent, and a catalyst with a phosphorus-based antioxidant and a hindered amine-based light stabilizer (Japanese Patent Application Publication No. 2010-100717 (PTL 1)), and a method of producing a flexible polyurethane foam with non-yellowing properties by using a polyurethane foam raw material containing at least a polyol component, an aliphatic or alicyclic polyisocyanate component, a foam stabilizer, a catalyst, and a foaming agent, the polyol component containing a specific polyoxyalkylene polyol (Japanese Patent Application Publication No. 2010-150438 (PTL 2)).

### CITATION LIST

### Patent Literature

[PTL 1] Japanese Patent Application Publication No. 2010-100717
[PTL 2] Japanese Patent Application Publication No. 2010-150438

### SUMMARY OF INVENTION

### Technical Problem

The present invention has been made in view of the above problem in the related art and has an object to provide a surface treatment agent capable of suppressing yellowing of a leather surface and a leather having yellowing-suppressed surface.

### Solution to Problem

The present inventors have conducted intensive studies to achieve the above-described object, and consequently have found that a cause for yellowing of a leather surface in a cushioning composite material in which a flexible polyurethane foam is laminated with any of various leathers by the flame lamination method is a NOx gas contained in a gas generated from the flexible polyurethane foam during burning by flame or other means, and have further found that yellowing of a leather surface due to the NOx gas can be suppressed by treating a surface of a leather base material with a surface treatment agent containing a compound having two or more active hydrogens per molecule. These findings have led to the completion of the present invention.

In sum, the present invention provides the following aspects.
[1] A surface treatment agent for leather comprising: an (A) resin capable of forming a resin layer on a surface of a leather base material; and a (B) compound having two or more active hydrogens per molecule.
[2] The surface treatment agent for leather according to the above [1], wherein the (B) compound having two or more active hydrogens per molecule is a compound having three or more hydroxyl groups per molecule.
[3] The surface treatment agent for leather according to the above [1] or [2], wherein the (B) compound having two or more active hydrogens per molecule is a glycerin-based compound.
[4] The surface treatment agent for leather according to any one of the above [1] to [3], wherein the (A) resin capable of forming a resin layer on a surface of a leather base material is at least one selected from the group consisting of polyurethane-based resins and acrylic resins.
[5] A leather comprising: a leather base material; and a surface treatment layer formed on a surface of the leather base material, the surface treatment layer formed of the surface treatment agent for leather according to any one of the above [1] to [4].
[6] A cushioning composite material comprising: a flexible polyurethane foam; and the leather according to [5] laminated to a surface of the flexible polyurethane foam.

### Advantageous Effects of Invention

According to the present invention, it is possible to provide a surface treatment agent capable of suppressing yellowing of a leather surface and a leather having yellowing-suppressed surface.

### DESCRIPTION OF EMBODIMENTS

Hereinafter, the present invention will be described in detail according to preferred embodiments thereof.

### [Surface Treatment Agent for Leather]

First, a surface treatment agent for leather of the present invention will be described. The surface treatment agent for leather of the present invention (hereinafter also simply referred to as the “surface treatment agent”) contains an (A) resin capable of forming a resin layer on a surface of a leather base material and a (B) compound having two or more active hydrogens per molecule. Hereinafter, each of the components will be described.

### (A) Resin

The (A) resin used in the present invention is not particularly limited as long as it is a resin capable of forming a resin layer on a surface of a leather base material, and is, for example, a resin generally used as a base resin for forming a resin layer (resin film) such as a polyurethane resin, an acrylic resin, a polyester resin, a polyolefin resin, a polyvinyl chloride resin, a silicone resin, a urethane acrylate resin, a vinyl acetate resin, an ethylene-vinyl acetate resin, a styrene-butadiene resin, an acrylonitrile-butadiene resin, a polyamide resin, or an epoxy resin. Any of these resins may be selected as appropriate depending on a material for a surface of a leather base material, and only one of them may be used or two or more of them may be used in combination. In the case where the material for the surface of the leather base material is a polyurethane resin, a polyvinyl chloride resin, or a polyolefin resin, the polyurethane resin or the acrylic resin is preferred among the above resins from the viewpoint of adhesion between the surface treatment layer formed of the surface treatment agent and the surface of the leather base material.

### (Polyurethane Resin)

The polyurethane resin is not particularly limited and examples thereof include polyurethane resins each obtained by reacting at least an organic polyisocyanate, a polyol, a polyamine having two or more amino groups and/or imino groups, and the like. A method for producing such a polyurethane resin is not particularly limited and a conventionally known method may be used. In the present invention, any of water-soluble and solvent-soluble polyurethane resins may be used.

Among the polyurethane resins, from the viewpoint of the wear resistance and bend resistance of the leather, a self-emulsifying type of water-soluble polyurethane resin is preferred in which a neutralized product of an isocyanate group-terminated prepolymer that is a reaction product of an (a) organic polyisocyanate, a (b) polyol, and a (c) compound having an anionic hydrophilic group and at least two active hydrogens is chain-extended with a (d) polyamine having two or more amino groups and/or imino groups. The term “water-soluble” in the self-emulsifying type of water-soluble polyurethane resin refers to an ability to create a state in which, even if an emulsion dispersion prepared by emulsifying and dispersing a self-emulsifying type of polyurethane resin in water such that the resin concentration is 35% by mass in the water is allowed to stand at 20° C. for 12 hours after the preparation, no separation or sedimentation is observed in the emulsion dispersion.

### (a) Organic Polyisocyanate

The (a) organic polyisocyanate is not particularly limited, and examples thereof include aromatic, aliphatic, and alicyclic polyisocyanates that have been generally used so far. For example, as the aromatic polyisocyanates, there are m-phenylene diisocyanate, p-phenylene diisocyanate, 2,4-tolylene diisocyanate, 2,6-tolylene diisocyanate, 4,4′-diphenylmethane diisocyanate, 2,4′-diphenylmethane diisocyanate, 3,3′-dimethyl-4,4′-biphenylene diisocyanate, 3,3′-dichloro-4,4′-biphenylene diisocyanate, 1,5-naphthalene diisocyanate, tolidine diisocyanate, tetramethylene xylylene diisocyanate, xylylene diisocyanate, and the like. As the aliphatic polyisocyanates, there are tetramethylene diisocyanate, pentamethylene diisocyanate, hexamethylene diisocyanate, dodecamethylene diisocyanate, trimethylhexamethylene diisocyanate, lysine diisocyanate, and the like. As the alicyclic polyisocyanates, there are isophorone diisocyanate, hydrogenated xylylene diisocyanate, 4,4′-dicyclohexylmethane diisocyanate, 3,3′-dimethyl-4,4′-dicyclohexylmethane diisocyanate, norbornane diisocyanate, 1,3-bis(isocyanatomethyl)cyclohexane, and the like. These organic polyisocyanates may be used alone or in combination of two or more. Among these organic polyisocyanates, aliphatic polyisocyanates and alicyclic polyisocyanates are preferred from the viewpoint that the obtained self-emulsifying type of water-soluble polyurethane resin has non-yellowing properties, and alicyclic polyisocyanates are more preferred from the viewpoint of heat resistance.

### (b) Polyol

The (b) polyol is not particularly limited, and examples thereof include conventionally known high-molecular polyols such as polyether-based polyols, polyester-based polyols, and polycarbonate-based polyols, conventionally known low-molecular weight diols, polyhydric alcohols having three or more active hydrogens, and so on. These polyols may be used alone or in combination of two or more. In the present specification, the high-molecular polyols and the low-molecular weight diols are collectively referred to as “(b1) polyol”, while the polyhydric alcohols having three or more active hydrogens are referred to as “(b2) polyhydric alcohol”. The (b1) polyol may be used alone or may be used in combination with the (b2) polyhydric alcohol. The (b2) polyhydric alcohol is preferably used in combination with the (b1) polyol.

The polyether-based polyols are not particularly limited, and examples thereof include polymers of alkylene oxides such as ethylene oxide, propylene oxide, and butylene oxide. Such a polymer may be a homopolymer of one type of alkylene oxide, or may be a copolymer of two or more types of alkylene oxides. In the case of a copolymer, the copolymer may be a random polymer or a block polymer. The molecular weight of such a polyether-based polyol is not particularly limited, but is preferably 400 to 5000. As the polyether-based polyol, a compound obtained by adding one type or two or more types of alkylene oxides to a low-molecular weight dihydric alcohol may be also used. As the low-molecular weight dihydric alcohol, there are ethylene glycol, propylene glycol, 1,4-butanediol, and the like.

The polyester-based polyols are not particularly limited, and examples thereof include: polyester-based polyols each obtained by a dehydration condensation reaction of a diol component such as ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, triethylene glycol, tetraethylene glycol, polyethylene glycol with a molecular weight of 300 to 1000, dipropylene glycol, tripropylene glycol, bishydroxyethoxybenzene, 1,4-cyclohexanedimethanol, bisphenol A, bisphenol S, hydrogenated bisphenol A, hydroquinone, or alkylene oxide adducts of these, with a dicarboxylic acid component such as dimer acid, succinic acid, adipic acid, azelaic acid, sebacic acid, dodecanedicarboxylic acid, maleic anhydride, fumaric acid, 1,3-cyclopentanedicarboxylic acid, terephthalic acid, isophthalic acid, phthalic acid, 1,4-naphthalenedicarboxylic acid, 2,5-naphthalenedicarboxylic acid, 2,6-naphthalenedicarboxylic acid, naphthalic acid, biphenyldicarboxylic acid, 1,2-bisphenoxyethane-p,p′-dicarboxylic acid, dicarboxylic acid anhydride, or ester-forming derivatives; polyester-based polyols each obtained by a ring-opening polymerization reaction of a cyclic ester compound such as ε-caprolactone; polyester-based polyols each obtained by a copolymerization of these; and the like.

The polycarbonate-based polyols are not particularly limited, and examples thereof include polycarbonate-based polyols each obtained by a reaction of glycol such as 1,3-propanediol, 1,4-butanediol, 2-methyl-1,3-propanediol, 1,5-pentanediol, 1,6-hexanediol, 3-methyl-1,5-pentanediol, 1,8-octanediol, 1,10-decanediol, or diethylene glycol with diphenyl carbonate, phosgene, or the like. The weight average molecular weight of such polycarbonate-based polyol is not particularly limited, but is preferably 500 to 3000, and more preferably 800 to 2500 from the viewpoints of the handling properties of the polycarbonate-based polyol and the bend resistance of the resulting leather.

The low-molecular weight diols are not particularly limited, and examples thereof include ethylene glycol, propylene glycol, diethylene glycol, 1,4-butanediol, 1,6-hexanediol, nonanediol, neopentyl glycol, and the like. The (b2) polyhydric alcohol is not particularly limited, and examples thereof include trivalent or higher low-molecular weight polyhydric alcohols, such as trimethylolpropane, pentaerythritol, and sorbitol. As the (b2) polyhydric alcohol, a compound having a molecular weight of 500 or less may be also used which is obtained by adding one type or two or more types of alkylene oxides to such a trivalent or higher low-molecular weight polyhydric alcohol or a low-molecular weight polyalkylenepolyamine. As the low-molecular weight polyalkylenepolyamine, there are ethylenediamine, diethylenetriamine, triethylenetetramine, and the like. As the alkylene oxides, there are an ethylene oxide, a propylene oxide, a butylene oxide, and the like. Among these (b2) polyhydric alcohols, trivalent or tetravalent (b2) polyhydric alcohols are preferred, and trivalent (b2) polyhydric alcohols are more preferred from the viewpoint of the wear resistance and bend resistance of the leather.

In the case where the (b2) polyhydric alcohol is used in the polyurethane resin, the ratio of the (b2) polyhydric alcohol to the total of the (b1) polyol, the (b2) polyhydric alcohol, and the (c) compound having an anionic hydrophilic group and at least two active hydrogens is preferably 0.1 to 1.5% by mass and more preferably 0.3 to 1.1% by mass from the viewpoint of the wear resistance and bend resistance of the leather.

### (c) Compound Having Anionic Hydrophilic Group and at Least Two Active Hydrogens

The (c) compound having an anionic hydrophilic group and at least two active hydrogens is not particularly limited, and is, for example, a compound having an anionic hydrophilic group such as a carboxyl group, a carboxylate group, a sulfo group, or a sulfonate group, and two or more active hydrogen-containing groups such as hydroxyl groups. As a result of a copolymerization with this (c) compound having an anionic hydrophilic group and at least two active hydrogens, a self-emulsifying type of water-soluble polyurethane resin is obtained. Examples of the (c) compound include 2,2-dimethylolpropionic acid, 2,2-dimethylolbutanoic acid, 2,2-dimethylolbutyric acid, 2,2-dimethylolvaleric acid, dihydroxymaleic acid, 2,6-dihydroxybenzoic acid, and the like. These (c) compounds may be used alone or in combination of two or more.

In the obtained self-emulsifying type of water-soluble polyurethane resin, a content of the anionic hydrophilic group is preferably 0.3 to 3.0% by mass and more preferably 0.5 to 2.5% by mass from the viewpoints of emulsion stability, storage stability and bend resistance of the leather.

### (d) Polyamine

The (d) polyamine is a compound having two or more amino groups and/or imino groups per molecule. The (d) polyamine is not particularly limited, and examples thereof include diamines such as ethylenediamine, propylenediamine, tetramethylenediamine, hexamethylenediamine, diaminocyclohexylmethane, hydrazine, 2-methylpiperazine, isophoronediamine, norboranediamine, diaminodiphenylmethane, tolylenediamine, and xylylenediamine; polyamines such as diethylenetriamine, triethylenetetramine, tetraethylenepentamine, and iminobispropylamine; amidoamine derived from diprimary amine and monocarboxylic acid; water-soluble amine derivatives such as monoketimine of diprimary amine; hydrazine derivatives such as dihydrazide oxalate, dihydrazide malonate, dihydrazide succinate, dihydrazide glutarate, dihydrazide adipate, dihydrazide sebacate, dihydrazide maleate, dihydrazide fumarate, dihydrazide itaconate, 1,1′-ethylenehydrazine, 1,1′-trimethylene hydrazine, and 1,1′-(1,4-butylene)dihydrazine. These (d) polyamines may be used alone or in combination of two or more. The amount of the (d) polyamine used is preferably such an amount that 0.8 to 1.2 equivalents of amino groups and/or the like are contained relative to the free isocyanate groups in the isocyanate group-terminated prepolymer to be described later.

### (Isocyanate Group-Terminated Prepolymer)

The isocyanate group-terminated prepolymer is a reaction product of the (a) organic polyisocyanate, the (b) polyol, and the (c) compound having an anionic hydrophilic group and at least two active hydrogens.

A method for producing such an isocyanate group-terminated prepolymer is not particularly limited, and examples thereof are conventionally known methods including a so-called one-shot method with a single stage, and an isocyanate polyaddition reaction method with multiple stages. The reaction temperature is preferably 40 to 150° C. In these methods, a reaction catalyst such as dibutyltin dilaurate, stannous octoate, dibutyltin di-2-ethylhexoate, triethylamine, triethylenediamine, N-methylmorpholine, or bismuth tris(2-ethylhexanoate) or a reaction inhibitor such as phosphoric acid, sodium hydrogen phosphate, p-toluenesulfonic acid, adipic acid, or benzoyl chloride may be added as needed.

Moreover, an organic solvent nonreactive with an isocyanate group may be added during the reaction or after the end of the reaction. Examples of such an organic solvent include acetone, methyl ethyl ketone, methyl isobutyl ketone, tetrahydrofuran, dioxane, dimethylformamide, dimethyl sulfoxide, toluene, xylene, ethyl acetate, butyl acetate, methylene chloride, and the like. Among these organic solvents, methyl ethyl ketone, toluene, and ethyl acetate are particularly preferable. These organic solvents can be removed by heating under reduced pressure after the emulsification and dispersion and the chain extension of the prepolymer.

In the production of the isocyanate group-terminated prepolymer, a mole ratio between isocyanate groups and hydroxyl groups in the raw materials (NCO/OH) is preferably 2.0/1.0 to 1.1/1.0 and more preferably 1.7/1.0 to 1.25/1.0. When the mole ratio between isocyanate groups and hydroxyl groups in the raw materials is adjusted within the above range, an isocyanate group-terminated prepolymer having a desired content of free isocyanate groups can be obtained. On the other hand, the content of free isocyanate groups tends to be too low if the mole ratio between isocyanate groups and hydroxyl groups in the raw materials falls below the above lower limit, or tends to be too high if the mole ratio exceeds the above upper limit.

The content of free isocyanate groups in the isocyanate group-terminated prepolymer thus obtained is preferably 0.2 to 3.0% by mass. If the content of free isocyanate groups falls below the above lower limit, the viscosity of the isocyanate group-terminated prepolymer during the production tends to increase significantly, so that a large amount of an organic solvent is required, which is disadvantageous in terms of cost, and the emulsification and dispersion tends to be difficult. On the other hand, if the content of free isocyanate groups exceeds the above upper limit, a balance of the water solubility between after the emulsification and dispersion and after the chain extension with the (d) polyamine tends to change greatly, and the storage stability over time or the processing stability of the water-soluble polyurethane resin may decrease. Moreover, the bend resistance of the leather may be lowered.

Since all of the (a) organic polyisocyanate, the (b) polyol, and the (c) compound having an anionic hydrophilic group and at least two active hydrogens have multiple reaction points, the isocyanate group-terminated prepolymer obtained by a reaction of the (a) organic polyisocyanate, the (b) polyol, and the (c) compound having an anionic hydrophilic group and at least two active hydrogens as described above has a complicated structure and cannot be directly represented by a general formula (structural formula).

### (Neutralized Product of Isocyanate Group-Terminated Prepolymer)

The neutralized product of the isocyanate group-terminated prepolymer is one obtained by neutralizing the anionic hydrophilic group in the isocyanate group-terminated prepolymer. The neutralized product of the isocyanate group-terminated prepolymer as described above may be produced by (i) neutralizing the anionic hydrophilic group in the isocyanate group-terminated prepolymer obtained by reacting the (a) organic polyisocyanate, the (b) polyol, and the (c) compound having an anionic hydrophilic group and at least two active hydrogens in a known method, or may be produced by (ii) mixing the (a) organic polyisocyanate, the (b) polyol, and the (c) compound having an anionic hydrophilic group and at least two active hydrogens, thereafter neutralizing the anionic hydrophilic group in the (c) compound in a known method, and then reacting the (c) compound thus neutralized with the (a) organic polyisocyanate and the (b) polyol. Instead, the neutralized product of the isocyanate group-terminated prepolymer may be also produced by (iii) reacting the (a) organic polyisocyanate, the (b) polyol, and the (c) compound in which the anionic hydrophilic group is a salt of the anionic hydrophilic group.

In the (i) and (ii) production methods, a basic compound used to neutralize the anionic hydrophilic group is not particularly limited, and examples thereof include: amines such as trimethylamine, triethylamine, tri-n-propylamine, tributylamine, N-methyl-diethanol amine, N, N-dimethylmonoethanolamine, N, N-diethylmonoethanolamine, and triethanolamine; hydroxides of alkali metals such as potassium hydroxide and sodium hydroxide; ammonia; and the like. Among these, tertiary amines such as trimethylamine, triethylamine, tri-n-propylamine, and tributylamine are particularly preferable.

When neutralizing the anionic hydrophilic group in the (i) and (ii) production methods, the amount of the basic compound for neutralization used is preferably 0.5 to 1.5 equivalents, more preferably 0.6 to 1.4 equivalents, and particularly preferably 0.7 to 1.3 equivalents relative to the anionic hydrophilic group. If the amount of the basic compound for neutralization used falls below the above lower limit, the emulsifiability and the storage stability of the water-soluble polyurethane resin tend to decrease. On the other hand, even if the basic compound for neutralization is added in an amount exceeding the above upper limit, the emulsifiability and the storage stability of the water-soluble polyurethane resin are not improved further, which is economically unfavorable.

### (Water-Soluble Polyurethane Resin)

The self-emulsifying type of water-soluble polyurethane resin is one obtained by chain-extending the neutralized product of the isocyanate group-terminated prepolymer with the (d) polyamine (chain-extended product).

### (Emulsification and Dispersion)

When chain-extending the neutralized product of the isocyanate group-terminated prepolymer, first, the neutralized product of the isocyanate group-terminated prepolymer is emulsified and dispersed in water. The emulsification and dispersion method is not particularly limited, and examples thereof include conventionally known methods using a homomixer, a homogenizer, a disperser, and the like. The neutralized product of the isocyanate group-terminated prepolymer can be emulsified and dispersed in water at a temperature in a range of 0 to 40° C. without addition of an emulsifier in particular. In this way, a reaction between the isocyanate groups and water can be inhibited. Moreover, when emulsifying and dispersing the neutralized product of the isocyanate group-terminated prepolymer, a reaction inhibitor such as phosphoric acid, sodium dihydrogen phosphate, disodium hydrogen phosphate, p-toluenesulfonic acid, adipic acid, or benzoyl chloride may be added as needed.

### (Chain Extension)

Next, the neutralized product of the isocyanate group-terminated prepolymer thus emulsified and dispersed in the water is chain-extended by using the (d) polyamine, thereby forming the self-emulsifying type of water-soluble polyurethane resin.

The chain extension method is not particularly limited, and a preferred example thereof is a chain extension method of adding the (d) polyamine to the emulsion dispersion of the neutralized product of the isocyanate group-terminated prepolymer or a chain extension method of adding the emulsion dispersion of the neutralized product of the isocyanate group-terminated prepolymer to the (d) polyamine. A reaction between the neutralized product of the isocyanate group-terminated prepolymer and the amine is generally completed at a reaction temperature of 20 to 50° C. within 30 to 120 minutes after the neutralized product of the isocyanate group-terminated prepolymer and the (d) polyamine are mixed.

Such chain extension may be performed simultaneously with the emulsification and dispersion, be performed after the emulsification and dispersion, or be performed before the emulsification and dispersion. In the case where the water-soluble polyurethane resin thus obtained contains an organic solvent, it is preferable to remove the organic solvent at a temperature of 30 to 80° C. under reduced pressure.

Here, since the (d) polyamine also has multiple reaction points as similar to the (a) organic polyisocyanate, the (b) polyol, and the (c) compound having an anionic hydrophilic group and at least two active hydrogens, the chain-extended product (the self-emulsifying type of water-soluble polyurethane resin) of the neutralized product of the isocyanate group-terminated prepolymer obtained by chain-extending the neutralized product of the isocyanate group-terminated prepolymer using the (d) polyamine as described above also has a complicated structure and cannot be directly represented by a general formula (structural formula), as similar to the foregoing isocyanate group-terminated prepolymer.

The self-emulsifying type of water-soluble polyurethane resin thus obtained is preferably used in a state emulsified and dispersed in water, and the resin component concentration is not particularly limited but is preferably 20 to 60% by mass. The resin component concentration in the water-based emulsion dispersion of the self-emulsifying type of water-soluble polyurethane resin can be adjusted with addition or removal of water.

### (Acrylic Resin)

As the acrylic resin, there are homopolymers and copolymers of acrylic monomers. Examples of the acrylic monomer include (meth)acrylic acid and derivatives thereof such as methyl (meth)acrylate, ethyl (meth)acrylate, 2-ethylhexyl (meth)acrylate, lauryl (meth)acrylate, stearyl (meth)acrylate, cyclohexyl (meth)acrylate, isobornyl (meth)acrylate, benzyl (meth)acrylate, (meth)acrylic acid, glycidyl (meth)acrylate, dimethylaminoethyl (meth)acrylate, diethylaminoethyl (meth)acrylate, 2-hydroxyethyl (meth)acrylate, and 2-hydroxypropyl (meth)acrylate. The (meth)acrylic acid mentioned herein means acrylic acid or methacrylic acid. These acrylic monomers may be used alone or in combination of two or more.

Examples of comonomer used in the acrylic resin include aromatic vinyl compounds such as styrene, α-methylstyrene, and p-methylstyrene; acrylamides such as acrylamide, diacetone acrylamide, methacrylamide and maleic acid amide; heterocyclic vinyl compounds such as vinylpyrrolidone; vinyl compounds such as vinyl chloride, acrylonitrile, vinyl ether, vinyl ketone, and vinylamide; α-olefins such as ethylene and propylene; maleic acid, fumaric acid, itaconic acid and derivatives thereof, and the like. These comonomers may be used alone or in combination of two or more.

The glass transition temperature (Tg) of the acrylic resin is preferably −40 to +50° C., more preferably −20 to +30° C., and most preferably −10 to +20° C. If the Tg of the acrylic resin falls below the above lower limit, the wear resistance and soil guard properties of the leather tend to decrease, whereas if the Tg exceeds the above upper limit, the wear resistance and soil guard properties of the leather tend to improve, but the bend resistance tends to decrease.

In the surface treatment agent of the present invention, a commercially available acrylic resin may be used as the acrylic resin. Examples of the commercially available acrylic resin include: Saivinol EC-065 (Tg=5° C.), Saivinol EC-071 (Tg=−20° C.), Saivinol EC-064 (Tg=−40° C.), Saivinol UC-6600 (Tg=50° C.), Saivinol EC-2020 (Tg=17° C.) (all manufactured by SAIDEN CHEMICAL INDUSTRY CO., LTD.), DURAFLEX 84S (Tg=0° C.), ORGAL P036V (Tg=0° C.), ORGAL D55HC (Tg=−3° C.), ORGAL DCS80 (Tg=−16° C.) (all manufactured by ORGANIK KIMYA), TOCRYL BCX-8111 (Tg=−30° C.), TOCRYL W-168 (Tg=−10° C.), TOCRYL X-4403 (Tg=−7° C.), TOCRYL W463 (Tg=11° C.), TOCRYL BCX-1160R-2 (Tg=12° C.), TOCRYL BCX-8104 (Tg=29° C.), and TOCRYL X-4402 (Tg=35° C.) (all manufactured by TOYOCHEM CO., LTD.), and the like.

### (B) Compound

The (B) compound used in the present invention is a compound having two or more active hydrogens per molecule. Examples of such (B) compound having two or more active hydrogens per molecule (hereinafter also simply referred to as the “(B) compound”) include a compound having two or more hydroxyl groups per molecule (such as polyhydric alcohol or polyhydric phenol) and a compound having two or more amino groups per molecule (such as polyamine). In addition, in the present invention, a compound in which an alkylene oxide is added to a compound having two or more active hydrogens per molecule such as polyhydric alcohol, polyhydric phenol, amine, polycarboxylic acid, or phosphoric acid may be used as the (B) compound. Furthermore, water-soluble polymers such as polyvinyl alcohol, carboxymethylcellulose, xanthan gum, and starch may be also used as the (B) compound. These (B) compounds having two or more active hydrogens per molecule may be used alone or in combination of two or more. Among these (B) compounds having two or more active hydrogens per molecule, a compound having three or more (more preferably four or more, further preferably five or more, and particularly preferably six or more) hydroxyl groups per molecule (particularly, glycerin-based compound (glycerin and polyglycerin)) is preferred from the viewpoint that the yellowing of the leather surface can be sufficiently suppressed.

### (Polyhydric Alcohol)

Examples of the polyhydric alcohol include dihydric alcohols having 2 to 20 carbon atoms (such as aliphatic diols and alicyclic diols), trihydric alcohols having 3 to 20 carbon atoms (such as aliphatic triols), and polyhydric alcohols of tetravalent or higher (preferably tetravalent to octavalent) having 5 to 20 carbon atoms (such as aliphatic polyols, sugars, and their derivatives). These polyhydric alcohols may be used alone or in combination of two or more.

Examples of the aliphatic diols include alkylene glycols such as ethylene glycol, propylene glycol, 1,3- or 1,4-butanediol, 1,6-hexanediol, and neopentyl glycol. Examples of the alicyclic diols include cycloalkylene glycols such as cyclohexane diol and cyclohexanedimethanol. Examples of the aliphatic triols include alkane triols such as glycerin, trimethylolpropane, trimethylolethane, and hexanetriol. Examples of the aliphatic polyols include alkane polyols such as pentaerythritol, sorbitol, mannitol, and sorbitan, and their intramolecular or intermolecular dehydration products (for example, dipentaerythritol), as well as intramolecular or intermolecular dehydration products of the alkane triols (for example, polyglycerins such as diglycerin, triglycerin, tetraglycerin, pentaglycerin, hexaglycerin, and decaglycerin). Examples of the sugars include sucrose, glucose, mannose, fructose, and methyl glucoside.

### (Glycerin-Based Compound)

The glycerin-based compound (glycerin and polyglycerin) is a compound represented by the following formula (1):

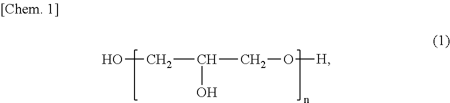

where n is an integer of 1 to 20. Among these glycerin-based compounds, polyglycerin in which n in the above formula (1) is 2 to 20 is preferred, polyglycerin in which n in the above formula (1) is 3 to 20 is more preferred, and polyglycerin in which n in the above formula (1) is 4 to 20 is even more preferred from the viewpoint that the yellowing of the leather surface can be sufficiently suppressed. The upper limit of n in the above formula (1) is preferably 10 or less from the viewpoint of the texture and the stability of the treatment solution.

In the present invention, the average polymerization degree of polyglycerin is preferably 1 to 10 and more preferably 2 to 10 from the viewpoint of the ability to suppress yellowing of the leather surface. Here, “the average polymerization degree of polyglycerin” is a value calculated from the hydroxyl value of the polyglycerin (including a mixture of glycerin and polyglycerin) determined by a terminal group analysis method. Specifically, first, an amount of acetic acid required to acetylate the free hydroxyl groups contained in the polyglycerin (including the mixture of glycerin and polyglycerin) is determined using the terminal group analysis method, and then an amount of calcium hydroxide required to neutralize this amount of acetic acid is determined. This amount of calcium hydroxide is the hydroxyl value [unit: mgKOH/g] of the polyglycerin (including the mixture of glycerin and polyglycerin). The average polymerization degree Xn of the polyglycerin (including the mixture of glycerin and polyglycerin) is calculated in accordance with the following formulae (I) and (II) using the above hydroxyl value.

$$Molecular Weight = 74 \times Xn + 18 \qquad ( I )$$

$$Hydroxyl Value = 56110 \times ( Xn + 2 ) / Molecular Weight \qquad ( II )$$

The average polymerization degree of glycerin alone can be also calculated to be 1 in the foregoing method.

In the present invention, as the polyglycerin, polyglycerin synthesized as appropriate may be used or commercially available polyglycerin may be used. As the commercially available polyglycerin, there are Diglycerin S, Polyglycerin #310, Polyglycerin #500, and Polyglycerin #750 (all are product names, manufactured by Sakamoto Yakuhin Kogyo Co., Ltd.) and the like.

### (Polyhydric Phenol)

Examples of the polyhydric phenol include monocyclic polyhydric phenols such as pyrogallol, hydroquinone, and phloroglucin; bisphenols such as bisphenol A, bisphenol F, and bisphenol sulfone; and condensates of phenols and formaldehyde (novolaks); and the like. These polyhydric phenols may be used alone or in combination of two or more.

### (Polyamine)

The polyamine is a compound having two or more amino groups and/or imino groups per molecule. Such polyamine is not particularly limited, and examples thereof include diamines such as ethylenediamine, propylenediamine, tetramethylenediamine, hexamethylenediamine, diaminocyclohexylmethane, hydrazine, 2-methylpiperazine, isophoronediamine, norboranediamine, diaminodiphenylmethane, tolylenediamine, and xylylenediamine; polyamines such as diethylenetriamine, triethylenetetramine, tetraethylenepentamine, and iminobispropylamine; amidoamine derived from diprimary amine and monocarboxylic acid; water-soluble amine derivatives such as monoketimine of diprimary amine; hydrazine derivatives such as dihydrazide oxalate, dihydrazide malonate, dihydrazide succinate, dihydrazide glutarate, dihydrazide adipate, dihydrazide sebacate, dihydrazide maleate, dihydrazide fumarate, dihydrazide itaconate, 1,1′-ethylenehydrazine, 1,1′-trimethylene hydrazine, and 1,1′-(1,4-butylene)dihydrazine. These polyamines may be used alone or in combination of two or more.

### <Surface Treatment Agent>

The surface treatment agent of the present invention contains the (A) resin capable of forming a resin layer on a surface of a leather base material and the (B) compound having two or more active hydrogens per molecule. When a surface of a leather base material is treated with such a surface treatment agent, a surface treatment layer is formed on the surface of the leather base material by the surface treatment agent. As a result, even if the leather base material has yellowing properties, the yellowing of the leather surface can be suppressed by this surface treatment layer.

In the surface treatment agent of the present invention, the mass ratio between the (A) resin and the (B) compound can be set as appropriate depending on the degree of yellowing of the leather surface. However, in general, the content of the (B) compound is preferably 0.1 to 50 parts by mass and more preferably 1 to 10 parts by mass relative to 100 parts by mass of the (A) resin. If the content of the (B) compound falls below the above lower limit, the yellowing of the leather surface tends to be insufficiently suppressed, whereas if the content of the (B) compound exceeds the above upper limit, the quality of the leather surface tends to be deteriorated (for example, the tactile sensation deteriorates due to the occurrence of sticky feel).

In addition to the (A) resin and the (B) compound, the surface treatment agent of the present invention may contain a reaction catalyst and various additives such as fluorine-containing compounds, hydrophilic compounds, matting agents, smoothing agents, thickeners, cross-linking agents, antifouling agents, surfactants, defoamers, leveling agents, viscoelasticity modifiers, wetting agents, dispersants, preservatives, film-forming agents, plasticizers, penetrating agents, fragrances, bactericides, miticides, fungicides, ultraviolet absorbers, antioxidants, antistatic agents, flame retardants, dyes, and pigments, unless they will impair the purpose and performance of the present invention.

### (Fluorine-Containing Compound)

The surface treatment agent of the present invention may contain a fluorine-containing compound in order to impart SG properties (soil guard: an ability of anti-adhesion of soil itself) to the leather surface. Such fluorine-containing compound is not particularly limited as long as it is a compound having a fluorine-containing hydrocarbon group (for example, a fluoroalkyl group (preferably having 1 to 6 carbon atoms) or a fluoroalkenyl group (preferably having 2 to 6 carbon atoms), or preferably a perfluoroalkyl group (more preferably having 1 to 6 carbon atoms) or a perfluoroalkenyl group (more preferably having 2 to 6 carbon atoms), but is preferably a fluorine-based polymer containing a repeating unit derived from a fluorine-based monomer having the fluorine-containing hydrocarbon group. The fluorine-based polymer may be a homopolymer or a copolymer of the fluorine-based monomers, and the copolymer of the fluorine-based monomers may be a copolymer of two or more kinds of the fluorine-based monomers or a copolymer of one or more kinds of the fluorine-based monomers and one or more kinds of non-fluorine-based monomers.

The content of such fluorine-containing compound is preferably 10 to 100 parts by mass and more preferably 30 to 70 parts by mass relative to 100 parts by mass of the (A) resin from the viewpoint of the SG properties.

In addition, the fluorine-containing compound has a water repellency of grade 3 or higher in the following water-repellency test.

### <Water Repellency Test>

A dyed fabric made of 100% polyester (basis weight 100 g/m²) is immersed in an aqueous solution adjusted such that an amount of the fluorine-containing compound adhering to the fabric is 10% by mass (a pickup rate of 60%), then dried at 130° C. for 1 minute, and then further heated at 180° C. for 30 seconds. Next, the resultant treated fabric is subjected to the water repellency test according to the method described in JIS L1092 (2009) 7.2 Water Repellency Test (Spray Test), and the water repellency of the treated fabric is evaluated according to the following criteria.

### (Water Repellency Evaluation Criteria)

Grade 5: The front surface of the treated fabric is free of wetting and water droplets.
Grade 4: The front surface of the treated fabric is slightly wet with few water droplets.
Grade 3: The front surface of the treated fabric is partially wet.
Grade 2: The front surface of the treated fabric is wet.
Grade 1: The front and back surfaces of the treated fabric are completely wet.

The fluorine-based monomer is preferably a monomer having the fluorine-containing hydrocarbon group and a polymerizable functional group, and the polymerizable functional group is preferably an acrylic acid group, a methacrylic acid group, or an x-substituted acrylic acid group. The x-substituted acrylic acid group refers to a group in which the hydrogen atom bonded to the carbon atom at the x-position of the acrylic acid group is substituted with a halogen atom, a cyano group, a trifluoromethyl group, or the like.

Such fluorine-based monomer is preferably a compound represented by the following formula (2):

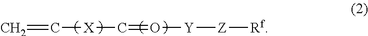

In the above formula (2), X represents a hydrogen atom, a halogen atom (preferably, a fluorine atom, a chlorine atom, a bromine atom, or an iodine atom), or a monovalent organic group; the monovalent organic group is preferably a linear or branched alkyl group having 1 to 21 carbon atoms (more preferably 1 to 10 carbon atoms and even more preferably 1 to 5 carbon atoms), a —CFX¹X² group (X¹ and X² represent a hydrogen atom or a halogen atom (more preferably, a fluorine atom, a chlorine atom, a bromine atom, or an iodine atom)), a cyano group, a linear or branched fluoroalkyl group having 1 to 21 carbon atoms (more preferably 1 to 10 carbon atoms and even more preferably 1 to 5 carbon atoms), a substituted or unsubstituted benzyl group, or a substituted or unsubstituted phenyl group. Among them, X is preferably a hydrogen atom, a fluorine atom, a chlorine atom, a bromine atom, an iodine atom, a methyl group, a cyano group, and a trifluoromethyl group, and is more preferably a chlorine atom.

Y represents —O— or —NH—; and is preferably —O—.

Z represents a direct bond or a divalent organic group; and preferred examples of the divalent organic group include a linear or branched divalent aliphatic group (more preferably a saturated aliphatic group) having 1 to 20 carbon atoms (more preferably 1 to 10 carbon atoms, further preferably 1 to 4 carbon atoms, and particularly preferably 1 or 2 carbon atoms), a divalent substituted or unsubstituted aromatic group having 6 to 18 carbon atoms (more preferably 6 to 12 carbon atoms), a divalent substituted or unsubstituted cyclic aliphatic group having 3 to 18 carbon atoms (more preferably 6 to 18 carbon atoms and further preferably 6 to 12 carbon atoms), a —R¹N(R²)—Z¹-group (R¹ represents a linear or branched alkylene group having 1 to 10 carbon atoms (more preferably 1 to 4 carbon atoms and further preferably 1 or 2 carbon atoms), and R² represents a linear or branched alkyl group having 1 to 10 carbon atoms (more preferably 1 to 4 carbon atoms)), and Z¹ represents —SO₂— or —C(═O)—), a —CH₂CH(OZ²)CH₂—(Ar—O)ₚ— group (Z² represents a hydrogen atom or an acyl group (such as a formyl group or an acetyl group) having 1 to 10 carbon atoms (more preferably 1 to 4 carbon atoms), Ar represents a substituted or unsubstituted arylene group having 6 to 18 carbon atoms (more preferably 6 to 12 carbon atoms), and p is 0 or 1), a —(CH₂)ₙ—Ar—(O)_{q}— group (Ar represents a substituted or unsubstituted arylene group having 6 to 18 carbon atoms (more preferably 6 to 12 carbon atoms), n is an integer of 0 to 10 (more preferably 0 to 5), and q is 0 or 1), and a —(CH₂)ₘ-Z³—(CH₂)ₙ— group (Z³ represents —SO₂— or —S—, m is an integer of 1 to 10 (more preferably 1 to 5), and n is an integer of 0 to 10 (more preferably 0 to 5)). Among these, Z is more preferably a linear or branched divalent aliphatic group (further preferably a saturated aliphatic group) having 1 to 10 carbon atoms (further preferably 1 to 4 carbon atoms and particularly preferably 1 or 2 carbon atoms), a divalent substituted or unsubstituted aromatic group having 6 to 18 carbon atoms (further preferably 6 to 12 carbon atoms), a divalent substituted or unsubstituted cyclic aliphatic group having 6 to 18 carbon atoms (more preferably 6 to 12 carbon atoms), a —CH₂CH₂N(R²)—SO₂— group (R² represents a linear or branched alkyl group having 1 to 4 carbon atoms), a —CH₂CH(OZ²)CH₂—(Ph-O)ₚ— group (Z² represents a hydrogen atom or an acetyl group, Ph represents a phenylene group, and p is 0 or 1), a —(CH₂)ₙ-Ph-O— group (Ph represents a phenylene group and n is an integer of 0 to 10 (more preferably 0 to 5)), or a —(CH₂)ₘ-Z³—(CH₂)ₙ— group (Z³ represents —SO₂— or —S—, m is an integer of 1 to 10 (more preferably 1 to 5), and n is an integer of 0 to 10 (more preferably 0 to 5)).

R^{f} represents a linear or branched fluoroalkyl group (preferably a perfluoroalkyl group) having 1 to 20 carbon atoms (preferably 1 to 10 carbon atoms, more preferably 1 to 6 carbon atoms, further preferably 4 to 6 carbon atoms, and particularly preferably 6 carbon atoms).

The non-fluorine-based monomer is a monomer not containing any fluorine atom but having a polymerizable functional group, and the polymerizable functional group is preferably a functional group having an ethylenically unsaturated double bond, such as an acrylic acid group, a methacrylic acid group, or an α-substituted acrylic acid group. The α-substituted acrylic acid group refers to a group in which the hydrogen atom bonded to the carbon atom at the α-position of the acrylic acid group is substituted with a halogen atom other than a fluorine atom, a cyano group, or the like.

In the surface treatment agent of the present invention, a commercially available fluorine-containing compound may be used as the fluorine-containing compound. As the commercially available fluorine-containing compounds, there are NK Guard S-0671, NK Guard S-0521, NK Guard S-05, NK Guard S-0543, NK Guard S-740, NK Guard S-0546, NK Guard S-0545, NK Guard S-1115, and NK Guard S-0672 (all manufactured by NICCA Chemical Co., Ltd.), Unidyne TG-5574, Unidyne TG-4575, Unidyne TG-5543, Unidyne TG-5546, Unidyne TG-5545, Unidyne TG-5601, Unidyne TG-5541, Unidyne TG-4571, Unidyne TG-6071, Unidyne TG-6501, Unidyne TG-5671, Unidyne TG-5672, Unidyne TG-5673, and Unidyne TG-9011 (all manufactured by Daikin Industries, Ltd.), Asahi Guard AG-E060, Asahi Guard AG-E061, Asahi Guard AG-7000, Asahi Guard AG-950, Asahi Guard AG-E081, Asahi Guard AG-E082, Asahi Guard AG-E092, and Asahi Guard AG-E500D (all manufactured by AGC Inc.), Max Guard FX-850, Max Guard FX-860, and Max Guard FX-880 (all manufactured by Kyoken Kasei), Para Guard AF660 (manufactured by Ohara Palladium Chemical Co., Ltd.), NUVA2114 (manufactured by Clariant Japan K.K.), Scotch Guard PM3622, Scotch Guard PM490, and Scotch Guard PM930 (all manufactured by 3M Ltd.), and the like.

### (Hydrophilic Compound)

The surface treatment agent of the present invention may contain a hydrophilic compound in order to impart SR properties (soil release: the ability to easily remove soil by wiping with water even if the soil adheres) to the leather surface. Such hydrophilic compounds include polyester-based hydrophilic compounds, urethane-based hydrophilic compounds other than the self-emulsifying type of water-soluble polyurethane resin, silicone-based hydrophilic compounds, water-soluble polymer compounds, and the like.

The content of such hydrophilic compound is preferably 5 to 50 parts by mass and more preferably 15 to 40 parts by mass relative to 100 parts by mass of the (A) resin from the viewpoint of the SR properties.

Furthermore, the hydrophilic compound is one that will leave no residue when an aqueous solution in which the hydrophilic compound is dissolved at a concentration of 10% by mass is filtered using a polyester gauze (mesh opening 79 μm).

Among these hydrophilic compounds, polyester-based hydrophilic compounds are preferred, hydrophilic polyester copolymers containing a polyhydric carboxylic acid component unit or an ester-forming derivative component unit thereof and a polyhydric alcohol component unit are more preferred, and the hydrophilic polyester copolymers having an aromatic ring in the chain unit are even more preferred. Examples of the hydrophilic polyester copolymer having an aromatic ring include copolymers of an aromatic polyhydric carboxylic acid or an ester-forming derivative thereof with polyhydric alcohol.

Examples of the aromatic polyhydric carboxylic acid include terephthalic acid, isophthalic acid, orthophthalic acid, 1,4-naphthalenedicarboxylic acid, 2,5-naphthalenedicarboxylic acid, 2,6-naphthalenedicarboxylic acid, and the like. Examples of the ester-forming derivative of the aromatic polyhydric carboxylic acid include lower alkyl esters (for example, methyl esters, ethyl esters, propyl esters, dibutyl esters, and so on) of the aromatic polyhydric carboxylic acids, salts (for example, chlorides, and so on) of the aromatic polyhydric carboxylic acids, phthalic anhydride, and the like.

Furthermore, as the aromatic polyhydric carboxylic acid, an aromatic polyhydric carboxylic acid having a sulfonate group may be used. Examples of the aromatic polyhydric carboxylic acid having a sulfonate group include metal sulfonates (preferably sodium salts and potassium salts) of aromatic dicarboxylic acids having a sulfonate group (for example, sulfoterephthalic acid, 5-sulfoisophthalic acid, 4-sulfophthalic acid, 5-sulfoisophthalic acid, 4-sulfonaphthalene-2,7-dicarboxylic acid, 5-(4-sulfophenoxy)isophthalic acid, and so on), metal sulfonates (preferably sodium salts and potassium salts) of the lower alkyl esters of the aromatic dicarboxylic acids having a sulfonate group, and the like.

These aromatic polyhydric carboxylic acids (including the aromatic polyhydric carboxylic acid having a sulfonate group) and their ester-forming derivatives may be used alone or in combination of two or more. In addition, it is more preferable to use an aromatic polyhydric carboxylic acid having no sulfonate group and an aromatic polyhydric carboxylic acid having a sulfonate group in combination in order to improve the water solubility or emulsifiability and dispersibility of the hydrophilic polyester copolymer and soil guard properties of the leather.

The polyhydric alcohols include: aliphatic diols such as ethylene glycol, 1,2-propylene glycol, 1,3-propylene glycol, 1,2-butylene glycol, 1,3-butylene glycol, 2,3-butylene glycol, 1,4-butylene glycol, 2-methyl-1,3-propylene glycol, neopentyl glycol, 1,5-pentanediol, 1,6-hexanediol, 3-methyl-1,5-pentanediol, 2,2,4-trimethyl-1,3-pentanediol, 2,4-diethyl-1,5-pentanediol, 2-ethyl-1,3-hexanediol, 2,2-dimethyl-3-hydroxypropyl-2,2′-dimethyl-3-hydroxypropanate, 2-n-butyl-2-ethyl-1,3-propanediol, and 3-ethyl-1,5-pentanediol, 3-propyl-1,5-pentanediol, 2,2-diethyl-1,3-propanediol, 3-octyl-1,5-pentanediol, diethylene glycol, triethylene glycol, tetraethylene glycol, dipropylene glycol, tripropylene glycol, polyethylene glycols with a molecular weight 300 to 10000, and random or block copolymers of ethylene oxide and propylene oxide; alicyclic diols such as 1,3-bis(hydroxymethyl)cyclohexane, 1,4-bis(hydroxymethyl)cyclohexane, 1,4-bis(hydroxyethyl)cyclohexane, 1,4-bis(hydroxypropyl)cyclohexane, 1,4-bis(hydroxymethoxy)cyclohexane, 1,4-bis(hydroxyethoxy)cyclohexane, 2,2-bis(4-hydroxymethoxycyclohexyl)propane, 2,2-bis(4-hydroxyethoxycyclohexyl)propane, bis(4-hydroxycyclohexyl)methane, 2,2-bis(4-hydroxycyclohexyl)propane, and 3(4),8(9)-tricyclo[5.2.1.0^{2,6}]decanedimethanol; aromatic diols such as bishydroxyethoxybenzene, bisphenol A, bisphenol S, and hydroquinone; and alkylene oxide adducts of these. These polyhydric alcohols may be used alone or in combination of two or more. Among these polyhydric alcohols, a diol having an oxyethylene group, such as polyethylene glycol, is preferred from the viewpoint that the emulsion dispersion of the hydrophilic polyester copolymer is stable over time.

The weight average molecular weight of the polyester-based hydrophilic compound is preferably 1000 to 200000, and more preferably 10000 to 50000. If the weight average molecular weight of the polyester-based hydrophilic compound falls below the above lower limit, the SR properties of the leather may not be sufficiently exhibited, whereas if it exceeds the above upper limit, the polyester-based hydrophilic compound may have a too high viscosity and be difficult to handle.

In the surface treatment agent of the present invention, a commercially available hydrophilic compound may be used as the hydrophilic compound. The commercially available hydrophilic compounds include NICEPOLE PR-99, NICEPOLE PR-9000, and NICEPOLE PRK-60 (all manufactured by Nicca Chemical Co., Ltd.), Hydroperm NIOPOs (manufactured by Archroma), and the like.

### (Matting Agent)

The surface treatment agent of the present invention may contain a matting agent in order to adjust the glossy texture and luster of the leather surface. Examples of the matting agent described above include organic beads, silica particles, talc, aluminum hydroxide, calcium sulfate, calcium silicate, calcium carbonate, magnesium carbonate, barium carbonate, alumina silicate, kaolin, mica, and the like. These matting agents may be used alone or in combination of two or more.

Examples of the organic beads include urethane beads, acrylic beads, silicone beads, olefin beads, high-density polyethylene, low-density polyethylene, and the like. Examples of the silica particles include dry silica, wet silica, and the like. Among them, dry silica is preferable from the viewpoints that the scattering effect is high and the gloss value can be adjusted with a small amount. The average particle size (average secondary particle size) of the dry silica is preferably 4 to 15 μm and more preferably 5 to 12 μm.

Regarding the content of such matting agent, an appropriate amount may be used depending on the matte texture (glossy texture or luster) of the leather surface, but the content of the matting agent is usually preferably 1 to 150 parts by mass, more preferably 5 to 120 parts by mass, and further preferably 7 to 100 parts by mass relative to 100 parts by mass of the (A) resin.

### (Smoothing Agent)

The surface treatment agent of the present invention may contain a smoothing agent in order to improve the smoothness and the wear resistance of the leather surface. Examples of the smoothing agent include polydimethyl silicone, hydrogen-modified silicone, vinyl-modified silicone, epoxy-modified silicone, amino-modified silicone, carboxyl-modified silicone, halogenated silicone, methacryloxy-modified silicone, mercapto-modified silicone, fluorine-modified silicone, alkyl-modified silicone, phenyl-modified silicone, polyether-modified silicone, and the like. These smoothing agents may be used alone or in combination of two or more. Among these smoothing agents, polydimethyl silicone and epoxy-modified silicone are preferable from the viewpoint that the effect of improving the wear resistance is high.

In the surface treatment agent of the present invention, a commercially available product may be used as the smoothing agent. Examples of a commercially available emulsion product of the polydimethyl silicone include DOWSIL SM490EX, DOWSIL SM-8706EX, DOWSIL IE-7046T, DOWSIL FBL-3289, and DOWSIL Q2-3238 (all manufactured by Dow Toray Co., Ltd.), KM-752T, KM-862T, KM-9737A, and POLON MF-33 (all manufactured by Shin-Etsu Chemical Co., Ltd.), and the like. Examples of a commercially available emulsion product of the epoxy-modified silicone include DOWSIL SM-8701 (manufactured by Dow Toray Co., Ltd.), POLON MF-18T and X-51-1264 (both manufactured by Shin-Etsu Chemical Co., Ltd.), and the like.

Regarding the content of such smoothing agent (content of a non-volatile component), an appropriate amount may be used depending on the smoothness and the wear resistance of the leather surface, but the content of the smoothing agent is preferably 1 to 150 parts by mass, more preferably 5 to 120 parts by mass, and further preferably 7 to 100 parts by mass relative to 100 parts by mass of the (A) resin, in general.

### (Thickener)

The surface treatment agent of the present invention may contain a thickener in order to adjust the viscosity to an appropriate level. Examples of such a thickener include alkali-thickening acrylic resins, associative thickeners, water-soluble organic polymers, and the like. These thickeners may be used alone or in combination of two or more.

In the surface treatment agent of the present invention, a commercially available product may be used as the alkali-thickening acrylic resin. Examples of the commercially available products of the alkali-thickening acrylic resins include Nikasol VT-253A (manufactured by Nippon Carbide Industry Co., Ltd.), ARON A-20P, ARON A-7150, ARON A-7070, ARON B-300, ARON B-300K, and ARON B-500 (all manufactured by Toagosei Co., Ltd.), JURYMER AC-10LHP, JURYMER AC-10SHP, RHEOGIC 835H, JUNLON PW-110, and JUNLON PW-150 (all manufactured by Nihon Junyaku Co., Ltd.), Primal ASE-60, Primal TT-615, and Primal RM-5 (all manufactured by Rohm and Haas Japan K.K.), SN Thickener A-818 and SN Thickener A-850 (both manufactured by San Nopco Limited), Paragum 500 (manufactured by Parachem Southern Inc.), RHEOLATE 430 (manufactured by Elementis Japan K.K.), Neo Sticker V-420 (manufactured by Nicca Chemical Co., Ltd.), and the like. In general, these alkali-thickening acrylic resins are commercially available as emulsion dispersions of resins and are preferably used in an emulsified and dispersed state.

Also, in the surface treatment agent of the present invention, a commercially available product may be used as the associative thickener. Examples of the commercially available products of the associative thickeners include ADEKA NOL UH-450, ADEKA NOL UH-540, and ADEKA NOL UH-752 (all manufactured by Asahi Denka Kogyo Co., Ltd.), SN Thickener 601, SN Thickener 612, SN Thickener 621N, SN Thickener 623N, and SN Thickener 660T (all manufactured by San Nopco Limited), RHEOLATE 244, RHEOLATE 278, and RHEOLATE 300 (all manufactured by Elementis Japan K.K.), DK Thickener SCT-275 (manufactured by DKS Co. Ltd.), and the like.

Examples of the water-soluble organic polymers include natural water-soluble organic polymers, semi-synthetic water-soluble organic polymers, and synthetic water-soluble organic polymers. As the natural water-soluble organic polymers, there are starches such as potato starch, sweet potato starch, wheat starch, rice starch, tapioca starch, and corn starch; resin polysaccharides such as gum arabic, gum tragacanth, gum karaya, and aibika; seaweed polysaccharides such as sodium alginate, carrageenan, agar (galactan), and funori (Gloiopeltis); microbially-fermented polysaccharides such as xanthan gum, pullulan, curdlan, dextrin, and levan; proteins such as casein, gelatin, albumin, glue, and collagen; pectin, chitin, chitosan, and the like.

As the semi-synthetic water-soluble organic polymers, there are cellulose derivatives such as methylcellulose, ethylcellulose, hydroxyethylcellulose, hydroxypropylcellulose, carboxymethylcellulose, and sodium cellulose sulfate; starch derivatives such as dextrin, soluble starch, oxidized starch, carboxymethyl starch, hydroxyethyl starch, hydroxypropyl starch, dialdehyde starch, starch phosphate, and acetyl starch; alginate propylene glycol ester, and the like.

As the synthetic water-soluble organic polymers, there are polyvinyl alcohol, polyvinylpyrrolidone, polyvinyl alkyl ether, maleic anhydride copolymer, maleic acid copolymer, maleate copolymer, and the like.

Regarding the content of such thickener (content of a non-volatile component), an appropriate amount may be used depending on the viscosity of the surface treatment agent, but the content of the thickener is preferably 0.5 to 40 parts by mass, more preferably 1 to 30 parts by mass, and further preferably 2 to 20 parts by mass relative to 100 parts by mass of the (A) resin, in general.

### (Cross-Linking Agent)

The surface treatment agent of the present invention may contain a cross-linking agent in order to improve the water resistance and the durability of the leather. As the cross-linking agent, there are carbodiimide-based cross-linking agents, isocyanate-based cross-linking agents, epoxy-based cross-linking agents, oxazoline-based cross-linking agents, aziridine-based cross-linking agents, blocked isocyanate-based cross-linking agents, water-dispersed isocyanate-based cross-linking agents, and melamine-based cross-linking agents, and the like. These cross-linking agents may be used alone or in combination of two or more. Among these cross-linking agents, the surface treatment agent particularly preferably contains a carbodiimide-based cross-linking agent from the viewpoints of the texture and the stability of the treatment solution.

In the surface treatment agent of the present invention, a commercially available product may be used as such a cross-linking agent. Examples of commercially available products of the carbodiimide-based cross-linking agent include CARBODILITE E-02, CARBODILITE SV-02, CARBODILITE V02-L2, and CARBODILITE V-10 (all manufactured by Nisshinbo Chemical Inc.), NK ASSIST CI-02 (manufactured by Nicca Chemical Co., Ltd.), and the like.

From the viewpoints of the wear resistance and bend resistance of the leather, the content of such cross-linking agent (content of a non-volatile component) is preferably 1 to 15 parts by mass and more preferably 2 to 10 parts by mass relative to 100 parts by mass of the (A) resin.

### (Reaction Catalyst)

The surface treatment agent of the present invention may contain a urethane reaction catalyst in order to further suppress yellowing of the leather surface. Such reaction catalysts include dibutyltin dilaurate, stannous octoate, dibutyltin di-2-ethylhexanoate, triethylamine, triethylenediamine, N-methylmorpholine, bismuth tris(2-ethylhexanoate), and the like. These reaction catalysts may be used alone or in combination of two or more. Among these reaction catalysts, surface treatment agent preferably contains an amine-based catalyst from the viewpoints of the environmental friendliness and the suppression of yellowing.

The content of such reaction catalyst is preferably 1 to 100 parts by mass and more preferably 10 to 50 parts by mass relative to 100 parts by mass of the (B) compound from the viewpoint of suppressing the yellowing of the leather surface.

### [Leather]

A leather of the present invention comprises a leather base material and a surface treatment layer formed on a surface of the leather base material. In order to improve the adhesion between these layers, a primer layer may be provided between the leather base material and the surface treatment layer.

### (Leather Base Material)

As the leather base material, there are synthetic leathers including a skin layer made of a polyurethane resin (PU), polyvinyl chloride (PVC) leathers, pseudo-leathers made of a polyurethane-based thermoplastic elastomer (TPU), artificial leathers, and natural leathers.

A structure of the leather base material may be a fiber laminate structure containing a fiber substrate and a skin layer. In the leather base material having such a structure, an adhesive layer and/or an intermediate layer may be provided between the fiber substrate and the skin layer as needed.

The fiber substrate may be a woven fabric, a nonwoven fabric, a knitted fabric, or the like. The skin layer may be a polyurethane resin layer. Such skin layer preferably has a thickness of 5 to 100 μm. The adhesive layer may be an adhesive layer formed by using a known adhesive such as a polyurethane-based adhesive. Such adhesive layer preferably has a thickness of 5 to 100 μm.

The leather base material as described above may be produced by, for example, the following method. First, a skin layer agent (for example, a polyurethane resin) is applied onto release paper with any of various coaters such as a gravure coater, a bar coater, a comma coater, a blade coater, and an air knife coater, and then appropriately dried to form a skin layer. Next, an adhesive (for example, a polyurethane-based adhesive) is applied onto this skin layer with any of various coaters such as a gravure coater, a bar coater, a comma coater, a blade coater, and an air knife coater, and then dried to form an adhesive layer. Subsequently, a fiber substrate is placed on a surface of this adhesive layer, pressure-bonded, and then allowed to mature. After that, the release paper is peeled off to obtain a fiber laminate (leather base material) containing the fiber substrate, the adhesive layer, and the skin layer.

### (Primer Layer)

In the leather of the present invention, the adhesion between the leather base material and the surface treatment layer may be improved by forming a primer layer on the surface (the surface of the skin layer) of the leather base material (the fiber laminate). The primer layer is a layer made of a resin, and may additionally contain known additives such as a matting agent, a smoothing agent, a thickener, a pigment, and/or an antioxidant as needed. As a method for forming the primer layer, there are a method of applying a primer to the surface of the leather base material with any of various coaters such as a gravure coater, a bar coater, a comma coater, a blade coater, and an air knife coater; a method of spraying a primer onto the surface of the leather base material; a method of immersing the leather base material into a primer; and other methods.

### (Surface Treatment Layer)

The leather of the present invention can be obtained by forming a surface treatment layer on the surface (the surface of the skin layer) (the surface of the primer layer when the primer layer is formed) of the leather base material (the fiber laminate). In the leather of the present invention, the surface treatment layer is formed by using the surface treatment agent of the present invention. The formation of the surface treatment layer on the surface of the leather base material by using the surface treatment agent of the present invention as described above makes it possible to suppress yellowing of the obtained leather surface even if the leather base material has yellowing properties. In addition, a cushioning composite material may be formed by, for example, laminating a flexible polyurethane foam with such leather in a flame lamination process or the like. Also in this cushioning composite material, it is possible to suppress yellowing of the leather surface (especially yellowing that may be caused by NOx generated in the flame lamination process or the like).

The method for forming the surface treatment layer on the leather base material is not particularly limited. For example, the surface treatment layer may be formed by applying the surface treatment agent onto the surface of the leather base material, followed by drying.

Examples of a method of applying the surface treatment agent include: a method of applying the surface treatment agent onto the surface of the leather base material with any of various coaters such as a gravure coater, a bar coater, a comma coater, a blade coater, or an air knife coater; a method of spraying the surface treatment agent onto the surface of the leather base material; a method of immersing the leather base material into the surface treatment agent; and other methods. Among them, a direct coating method and a reverse coating method using a gravure coater are more preferable. An amount of the surface treatment agent applied is preferably such that the amount of the agent applied and dried can be preferably 4 to 40 g/m² and more preferably 6 to 30 g/m². If the amount of the agent applied and dried falls below the above lower limit, the wear resistance and the soil guard properties of the leather may be insufficient, whereas if the amount of the agent applied and dried exceeds the above upper limit, the bending properties of the leather may deteriorate.

A method for drying the surface treatment agent applied is not particularly limited. For example, the surface treatment agent is preferably dried at a temperature in a range of 40 to 160° C. for 30 seconds to 10 minutes, or is more preferably dried at a temperature in a range of 80 to 130° C. for 30 seconds to 2 minutes. Then, after the drying, it is preferable to perform an aging treatment at a temperature in a range of 20 to 100° C. for 5 to 72 hours.

Leather products made of leathers produced in this way include interior materials for automobiles, motorcycle seats and grips, shoes, bags, clothing, sanitary products, outdoor tents, furniture, and so on.

### EXAMPLES

Hereinafter, the present invention will be described more specifically based on Examples and Comparative Examples; however, the present invention should not be limited to Examples below. In Synthesis Examples, the content of free isocyanate groups was measured in accordance with the following method.

### (Content of Free Isocyanate Groups)

In an Erlenmeyer flask, 0.3 g of a urethane prepolymer was placed and 10 ml of a 0.1N dibutylamine toluene solution was added to dissolve the urethane prepolymer. Next, several drops of a bromophenol blue solution were added, titration was carried out with a 0.1N hydrochloric acid methanol solution, and the content of free isocyanate groups NCO % was obtained in accordance with the following formula:

$$NCO \% = ( a - b ) \times 0.42 \times f / x$$

(In the above formula, a: a titration volume of the 0.1N hydrochloric acid methanol solution to titrate only 10 ml of the 0.1N dibutylamine toluene solution, b: a titration volume of the 0.1N hydrochloric acid methanol solution to titrate a solution in which the urethane prepolymer was dissolved, f: the factor of 0.1N hydrochloric acid methanol solution, and x: the amount of the urethane prepolymer).

The polyurethane resins used in Examples and Comparative Examples were synthesized in accordance with the following methods.

### Synthesis Example 1

In a four-necked flask equipped with a stirrer, a reflux condenser, a thermometer, and a nitrogen blowing tube, 71.7 parts by mass of polycarbonate diol (product name “DURANOL T5652” manufactured by Asahi Kasei Chemicals Corporation, an average molecular weight of 2,000), 0.4 parts by mass of trimethylolpropane, 3.1 parts by mass of dimethylolpropionic acid, and 32.9 parts by mass of methyl ethyl ketone were charged and uniformly mixed, and then 23.5 parts by mass of dicyclohexylmethane diisocyanate and 0.03 parts by mass of bismuth tris(2-ethylhexanoate) were added, followed by reaction at 80° C. for 240 minutes to obtain a methyl ethyl ketone solution of a urethane prepolymer in which the content of free isocyanate groups relative to the non-volatile content was 2.28%.

To this solution, 2.2 parts by mass of triethylamine was added, and the mixture was uniformly mixed and then was emulsified and dispersed with gradual addition of 185 parts by mass of water. To the resulting emulsion dispersion, 2.2 parts by mass of an aqueous solution of 30% hydrazine hydrate and 1.8 parts by mass of an aqueous solution of 20% diethylenetriamine were added, followed by stirring for 90 minutes to obtain a polyurethane dispersion. Subsequently, this polyurethane dispersion was desolvated at 40° C. under reduced pressure to obtain a stable aqueous dispersion of polyurethane (PUD-1) with a non-volatile content of 35.0% by mass, a viscosity of 50 mPa-s and an average particle size of 0.1 μm.

### Synthesis Example 2

In a four-necked flask equipped with a stirrer, a reflux condenser, a thermometer, and a nitrogen blowing tube, 61.9 parts by mass of polycarbonate diol (product name “DURANOL T5651” manufactured by Asahi Kasei Chemicals Corporation, an average molecular weight of 1,000), 0.2 parts by mass of trimethylolpropane, 3.1 parts by mass of dimethylolpropionic acid, and 32.9 parts by mass of methyl ethyl ketone were charged and uniformly mixed, and then 32.7 parts by mass of dicyclohexylmethane diisocyanate and 0.03 parts by mass of bismuth tris(2-ethylhexanoate) were added, followed by reaction at 80° C. for 240 minutes to obtain a methyl ethyl ketone solution of a urethane prepolymer in which the content of free isocyanate groups relative to the non-volatile content was 3.21%.

To this solution, 2.2 parts by mass of triethylamine was added, and the mixture was uniformly mixed and then was emulsified and dispersed with gradual addition of 185 parts by mass of water. To the resulting emulsion dispersion, 3.0 parts by mass of an aqueous solution of 30% hydrazine hydrate and 2.5 parts by mass of an aqueous solution of 20% diethylenetriamine were added, followed by stirring for 90 minutes to obtain a polyurethane dispersion. Subsequently, this polyurethane dispersion was desolvated at 40° C. under reduced pressure to obtain a stable aqueous dispersion of polyurethane (PUD-2) with a non-volatile content of 35.0% by mass, a viscosity of 20 mPa-s and an average particle size of 0.1 μm.

### Synthesis Example 3

In a four-necked flask equipped with a stirrer, a reflux condenser, a thermometer, and a nitrogen blowing tube, 71.7 parts by mass of polycarbonate diol (product name “Kuraray Polyol C-2090” manufactured by Kuraray Co., Ltd., an average molecular weight of 2,000), 0.4 parts by mass of trimethylolpropane, 3.1 parts by mass of dimethylolpropionic acid, and 32.9 parts by mass of methyl ethyl ketone were charged and uniformly mixed, and then 23.5 parts by mass of dicyclohexylmethane diisocyanate and 0.03 parts by mass of bismuth tris(2-ethylhexanoate) were added, followed by reaction at 80° C. for 240 minutes to obtain a methyl ethyl ketone solution of a urethane prepolymer in which the content of free isocyanate groups relative to the non-volatile content was 2.28%.

To this solution, 2.2 parts by mass of triethylamine was added, and the mixture was uniformly mixed and then was emulsified and dispersed with gradual addition of 185 parts by mass of water. To the resulting emulsion dispersion, 2.2 parts by mass of an aqueous solution of 30% hydrazine hydrate and 1.8 parts by mass of an aqueous solution of 20% diethylenetriamine were added, followed by stirring for 90 minutes to obtain a polyurethane dispersion. Subsequently, this polyurethane dispersion was desolvated at 40° C. under reduced pressure to obtain a stable aqueous dispersion of polyurethane (PUD-3) with a non-volatile content of 40.0% by mass, a viscosity of 40 mPa-s and an average particle size of 0.1 μm.

### Synthesis Example 4

In a four-necked flask equipped with a stirrer, a reflux condenser, a thermometer, and a nitrogen blowing tube, 350 parts by mass of polycarbonate diol (product name “DURANOL T5652” manufactured by Asahi Kasei Chemicals Corporation, an average molecular weight of 2,000) was charged and dehydrated at a degree of reduced pressure of 0.095 MPa at 120 to 130° C. After the dehydration, 650 parts by mass of N,N-dimethylformamide and 11 parts by mass of ethylene glycol were added and the mixture was thoroughly mixed while being cooled to 30° C. After that, 21 parts by mass of hexamethylene diisocyanate and 54 parts by mass of 4,4′-diphenylmethane diisocyanate were added, followed by mixing at 80° C. for 2 hours, and then 0.2 parts by mass of bismuth tris(2-ethylhexanoate) was added, followed by mixing at 100° C. for 8 hours. Subsequently, 360 parts by mass of methyl ethyl ketone was added to the resultant mixture while the mixture was being cooled to 70° C., thereby to obtain a urethane resin composition (PU-1) with a non-volatile content of 30.0% by mass.

### Example 1

As specified in Table 1, 10 parts by mass of solid content of the aqueous dispersion of polyurethane (PUD-1) obtained in Synthesis Example 1 as the (A) resin, 5 parts by mass of polyglycerin (“Polyglycerin #310” manufactured by Sakamoto Yakuhin Kogyo Co., Ltd., a polymerization degree: 4, a molecular weight: 314, an OH value: 1072, and number of OH group: 6) as the (B) compound, 9 parts by mass of solid content of an associative thickener (“SN Thickener 612” manufactured by San Nopco Ltd.), and 3 parts by mass of solid content of a water-dispersible carbodiimide-based cross-linking agent (“Carbodilite SV-02” manufactured by Nisshinbo Chemical Inc.) were uniformly mixed by use of a disperser to obtain a surface treatment agent.

### Examples 2 to 4

Each of the surface treatment agents was prepared in the same manner as in Example 1, except that 10 parts by mass of solid content of the aqueous dispersion of polyurethane (PUD-2) obtained in Synthesis Example 2, the aqueous dispersion of polyurethane (PUD-3) obtained in Synthesis Example 3, or the urethane resin composition (PU-1) obtained in Synthesis Example 4 was used as the (A) resin as specified in Table 1 in place of the aqueous dispersion of polyurethane (PUD-1) obtained in Synthesis Example 1.

### Example 5

The surface treatment agent was prepared in the same manner as in Example 1, except that 10 parts by mass of solid content of an acrylic resin emulsion (“Saivinol EC-065” manufactured by SAIDEN CHEMICAL INDUSTRY CO., LTD.) was used as the (A) resin as specified in Table 1 in place of the aqueous dispersion of polyurethane (PUD-1) obtained in Synthesis Example 1.

### Example 6

The surface treatment agent was prepared in the same manner as in Example 1, except that 30 parts by mass of solid content of a polydimethyl silicone emulsion (“KM-862T” manufactured by Shin-Etsu Chemical Co., Ltd.) was added as a smoothing agent to the mixture composition in Example 1 as specified in Table 1.

### Example 7

The surface treatment agent was prepared in the same manner as in Example 1, except that 20 parts by mass of solid content of an acrylic resin emulsion (“Saivinol EC-065” manufactured by SAIDEN CHEMICAL INDUSTRY CO., LTD.) was added as the (A) resin to the mixture composition in Example 1 as specified in Table 1.

### Example 8

The surface treatment agent was prepared in the same manner as in Example 7, except that 30 parts by mass of solid content of a polydimethyl silicone emulsion (“KM-862T” manufactured by Shin-Etsu Chemical Co., Ltd.) was added as a smoothing agent to the mixture composition in Example 7 as specified in Table 1.

### Example 9

The surface treatment agent was prepared in the same manner as in Example 8, except that 8 parts by mass of silica particles produced by dry process (“ACEMATT TS 100” manufactured by Evonik Degussa, an average particle size: 10 μm) was added as a matting agent to the mixture composition in Example 8 as specified in Table 1.

### Example 10

The surface treatment agent was prepared in the same manner as in Example 9, except that 8 parts by mass of solid content of a fluorine-based water- and oil-repellent agent (“NK Guard S-740” manufactured by NICCA CHEMICAL CO., LTD.) was added as the fluorine-containing compound, and 5 parts by mass of solid content of a polyester-based resin emulsion (“NICEPOLE PR-99” manufactured by NICCA CHEMICAL CO., LTD.) was added as the hydrophilic compound to the mixture composition in Example 9 as specified in Table 1.

### Examples 11 and 12

Each of the surface treatment agents was prepared in the same manner as in Example 10, except that the amount of the polyglycerin (“Polyglycerin #310” manufactured by Sakamoto Yakuhin Kogyo Co., Ltd.) was changed to the amount specified in Table 1.

### Examples 13

The surface treatment agent was prepared in the same manner as in Example 10, except that 2 parts by mass of solid content of triethylenediamine was added as a reaction catalyst to the mixture composition in Example 10 as specified in Table 1.

### Examples 14 to 24

Each of the surface treatment agents was prepared in the same manner as in Example 10, except that 5 parts by mass of polyglycerin (“Polyglycerin #510” manufactured by Sakamoto Yakuhin Kogyo Co., Ltd., a polymerization degree: 6, a molecular weight: 462, an OH value: 972, and number of OH group: 8), polyglycerin (“Polyglycerin #750” manufactured by Sakamoto Yakuhin Kogyo Co., Ltd., a polymerization degree: 10, a molecular weight: 758, an OH value: 888, and number of OH groups: 12), triglycerin (number of OH group: 5), diglycerin (number of OH group: 4), glycerin (number of OH group: 3), propanediol (number of OH group: 2), polyvinyl alcohol (“Kuraray Poval PVA-105” manufactured by Kuraray Co., Ltd., a polymerization degree: 500, and a saponification degree: 98.0 to 99.0%), polyvinyl alcohol (“Kuraray Poval PVA-117” manufactured by Kuraray Co., Ltd., a polymerization degree: 1,700, a saponification degree: 98.0 to 99.0%), polyvinyl alcohol (“Kuraray Poval PVA-124” manufactured by Kuraray Co., Ltd., a polymerization degree: 2,400, a saponification degree: 98.0 to 99.0%), polyvinyl alcohol (“Kuraray Poval PVA-217” manufactured by Kuraray Co., Ltd., a polymerization degree: 1,700, a saponification degree: 87.0 to 89.0%), or a polyimine compound (“Epomin SP-200” manufactured by Nippon Shokubai Co., Ltd., a molecular weight: 10,000) was used as the (B) compound as specified in Table 1 in place of the polyglycerin (“Polyglycerin #310” manufactured by Sakamoto Yakuhin Kogyo Co., Ltd.).

### Comparative Example 1

The surface treatment agent was prepared in the same manner as in Example 10, except that the (B) compound was not added as specified in Table 1.

### Comparative Examples 2 to 4

Each of the surface treatment agents was prepared in the same manner as in Example 10, except that 5 parts by mass of 2-propanol (number of OH group: 1), n-butanol (number of OH group: 1), or hexylamine (number of NH₂ group: 1) was used as the (B) compound as specified in Table 1 in place of the polyglycerin (“Polyglycerin #310” manufactured by Sakamoto Yakuhin Kogyo Co., Ltd.).

### <Production of Leather Base Material>

A skin agent containing 100 parts by mass of a polyurethane resin (“EVAFANOL HA-68” manufactured by Nicca Chemical Co., Ltd., a non-volatile content of 35% by mass), 5 parts by mass of a pigment (“SB White 11339W” manufactured by Mikuni-Color, Limited, a non-volatile content of 67.2% by mass), 1 part by mass of a water-dispersible carbodiimide-based cross-linking agent (“NK Assist CI-02” manufactured by NICCA CHEMICAL CO., LTD., a non-volatile content of 40% by mass), and 3 parts by mass of an associative thickener (“Neo Sticker S” manufactured by NICCA CHEMICAL CO., LTD.) was applied to release paper (“Asahi Release AR-148” manufactured by Asahi Roll Co., Ltd.) with a coating thickness of 100 μm (WET coating amount). By use of a dryer, the skin agent was pre-dried at 80° C. for 2 minutes, and then dried at 120° C. for 3 minutes to completely evaporate the water, thereby obtaining a polyurethane resin film (hereinafter referred to as the “skin layer”).

On this skin layer, a polyurethane adhesive mixture liquid containing 100 parts by mass of a two-component polyurethane resin (“EVAFANOL HO-38” manufactured by NICCA CHEMICAL CO., LTD., a main adhesive agent, a non-volatile content of 35% by mass), 7 parts by mass of a polyisocyanate-based curing agent (“NK ASSIST NY-27” manufactured by NICCA CHEMICAL CO., LTD., a non-volatile content of 100% by mass), and 5 parts by mass of an associative thickener (“Neo Sticker N” manufactured by Nicca Chemical Co., Ltd., a non-volatile content of 30% by mass) was applied with a coating thickness of 200 μm (WET coating amount).

Subsequently, the resultant skin layer was dried at 90° C. for one minute by use of the dryer. Immediately after the drying, a polyester knit as a fiber substrate was bonded onto the resultant skin layer. After that, the obtained laminate was cured at 120° C. for 3 minutes and then aged at 40° C. for 72 hours. The release paper was peeled off to obtain a leather base material (fiber laminate) for evaluation.

### <Production of Leather>

On the skin layer of the leather base material obtained above, the surface treatment agent obtained in each of Examples and Comparative Examples was applied by use of a 100-mesh gravure coater such that the amount of the applied and dried agent was 10 to 20 g/m², and then was dried with hot air at 125° C. for 3 minutes to prepare a leather for evaluation having a surface treatment layer. The gas-induced discoloration of each of the leathers was evaluated in accordance with the following method. The results are presented in Tables 1 and 2

### (Gas-Induced Discoloration)

The gas-induced discoloration of each of the leathers obtained above (in Examples 1 to 24 and Comparative Examples 1 to 4) was measured with a nitrogen oxide tester and a nitrogen oxide generator specified in JIS L0855 (1992).

Specifically, first, each of the leathers obtained above was cut in a size of 7 cm in length and 4 cm in width to prepare test pieces, a short side of each test piece was attached with a clip to a radial test holder (capacity: approximately 15 L), and then this sample holder was fixed to a frame inside a test vessel of the nitrogen oxide tester. At one time, 12 test pieces were set.

Next, 50 ml of a nitrogen oxide was taken out with a syringe from a nitrogen oxide storage vessel of the nitrogen oxide generator, and was injected from an inlet of the test vessel. Immediately after the injection, a propeller in the test vessel was rotated at approximately 270 rpm to distribute the nitrogen oxide to an even concentration in the test vessel. Sixty minutes after the injection of the nitrogen oxide, the rotation of the propeller was stopped, a lid of the tester was opened, and the test pieces were taken out into an air atmosphere. After the test pieces were air-dried, a degree of discoloration due to exposure to the nitrogen oxide was measured as a change of yellowness index with a colorimeter, and this change of yellowness index was graded based on a nine-grade scale from grade 5 to grade 1 based on Grayscale for assessing staining in accordance with JIS L0805 (2005). Note that, in this grade evaluation, the greater the grade number, the less the discoloration.

TABLE 1

| | | | Example | | | | | | | | | | | | | | |
|---|---|---|---|---|---|---|---|---|---|---|---|---|---|---|---|---|---|
| | | | 1 | 2 | 3 | 4 | 5 | 6 | 7 | 8 | 9 | 10 | 11 | 12 | 13 | 14 | 15 |
| (A) | PUD-1 | | 10 | | | | | 10 | 10 | 10 | 10 | 10 | 10 | 10 | 12 | 10 | 10 |
| | PUD-2 | | | 10 | | | | | | | | | | | | | |
| | PUD-3 | | | | 10 | | | | | | | | | | | | |
| | PU-1 | | | | | 10 | | | | | | | | | | | |
| | Acrylic Resin | | | | | | 10 | | 20 | 20 | 20 | 20 | 20 | 20 | 20 | 20 | 20 |
| (B) | Polyglycerin #310 | PD: 4, Number of OH group: 6 | 5 | 5 | 5 | 5 | 5 | 5 | 5 | 5 | 5 | 5 | 2 | 10 | 5 | | |
| | Polyglycerin #510 | PD: 6, Number of OH group: 8 | | | | | | | | | | | | | | 5 | |
| | Polyglycerin #750 | PD: 10, Number of OH group: 12 | | | | | | | | | | | | | | | 5 |
| | Triglycerin | Number of OH group: 5 | | | | | | | | | | | | | | | |
| | Diglycerin | Number of OH group: 4 | | | | | | | | | | | | | | | |
| | Glycerin | Number of OH group: 3 | | | | | | | | | | | | | | | |
| | Propanediol | Number of OH group: 2 | | | | | | | | | | | | | | | |
| | PVA-105 | PD: 500, SD: 98.0-99.0% | | | | | | | | | | | | | | | |
| | PVA-117 | PD: 1,700, SD: 98.0-99.0% | | | | | | | | | | | | | | | |
| | PVA-124 | PD: 2,400, SD: 98.0-99.0% | | | | | | | | | | | | | | | |
| | PVA-217 | PD: 1,700, SD: 87.0-89.0% | | | | | | | | | | | | | | | |
| | Epomin SP-200 | MW 10,000 | | | | | | | | | | | | | | | |
| | Isopropanol | Number of OH group: 1 | | | | | | | | | | | | | | | |
| | n-Butanol | Number of OH group: 1 | | | | | | | | | | | | | | | |
| | Hexylamine | Number of NH2 group: 1 | | | | | | | | | | | | | | | |

| | | | | | | | | | | | | | | | |
|---|---|---|---|---|---|---|---|---|---|---|---|---|---|---|---|
| Matting Agent | | | | | | | | | 8 | 8 | 8 | 8 | 8 | 8 | 8 |
| Smoothing Agent | | | | | | 30 | | 30 | 30 | 30 | 30 | 30 | 30 | 30 | 30 |
| Fluorine-containing Compound | | | | | | | | | | 8 | 8 | 8 | 8 | 8 | 8 |
| Hydrophilic Compound | | | | | | | | | | 5 | 5 | 5 | 5 | 5 | 5 |
| Thickener | 9 | 9 | 9 | 9 | 9 | 9 | 9 | 9 | 9 | 9 | 9 | 9 | 9 | 9 | 9 |
| Cross-Linking Agent | 3 | 3 | 3 | 3 | 3 | 3 | 3 | 3 | 3 | 3 | 3 | 3 | 3 | 3 | 3 |
| Reaction Catalyst | | | | | | | | | | | | | 2 | | |

| | | | | | | | | | | | | | | | |
|---|---|---|---|---|---|---|---|---|---|---|---|---|---|---|---|
| Total | 27 | 27 | 27 | 27 | 27 | 57 | 47 | 77 | 85 | 98 | 95 | 103 | 102 | 98 | 98 |
| Gas-induced Discoloration | 5 | 5 | 5 | 5 | 5 | 5 | 5 | 5 | 5 | 5 | 4 | 5 | 5 | 5 | 5 |

PD: Polymerization Degree,
SD: Saponification Degree,
MW: Molecular Weight

TABLE 2

| | | | | | | | | | | | | Comparative | | | |
|---|---|---|---|---|---|---|---|---|---|---|---|---|---|---|---|
| | | | Example | | | | | | | | | Example | | | |
| | | | 16 | 17 | 18 | 19 | 20 | 21 | 22 | 23 | 24 | 1 | 2 | 3 | 4 |
| (A) | PUD-1 | | 12 | 12 | 12 | 12 | 12 | 12 | 12 | 12 | 12 | 10 | 10 | 10 | 10 |
| | PUD-2 | | | | | | | | | | | | | | |
| | PUD-3 | | | | | | | | | | | | | | |
| | PU-1 | | | | | | | | | | | | | | |
| | Acrylic Resin | | 20 | 20 | 20 | 20 | 20 | 20 | 20 | 20 | 20 | 20 | 20 | 20 | 20 |
| (B) | Polyglycerin #310 | PD: 4, Number of OH group: 6 | | | | | | | | | | | | | |
| | Polyglycerin #510 | PD: 6, Number of OH group: 8 | | | | | | | | | | | | | |
| | Polyglycerin #750 | PD: 10, Number of OH | | | | | | | | | | | | | |
| | | group: 12 | | | | | | | | | | | | | |
| | Triglycerin | Number of OH group: 5 | 5 | | | | | | | | | | | | |
| | Diglycerin | Number of OH group: 4 | | 5 | | | | | | | | | | | |
| | Glycerin | Number of OH group: 3 | | | 5 | | | | | | | | | | |
| | Propanediol | Number of OH group: 2 | | | | 5 | | | | | | | | | |
| | PVA-105 | PD: 500, SD: 98.0-99.0% | | | | | 5 | | | | | | | | |
| | PVA-117 | PD: 1,700, SD: 98.0-99.0% | | | | | | 5 | | | | | | | |
| | PVA-124 | PD: 2,400, SD: 98.0-99.0% | | | | | | | 5 | | | | | | |
| | PVA-217 | PD: 1,700, SD: 87.0-89.0% | | | | | | | | 5 | | | | | |
| | Epomin SP-200 | MVV 10,000 | | | | | | | | | 5 | | | | |
| | Isopropanol | Number of OH group: 1 | | | | | | | | | | | 5 | | |
| | n-Butanol | Number of OH group: 1 | | | | | | | | | | | | 5 | |
| | Hexylamine | Number of NH2 group: 1 | | | | | | | | | | | | | 5 |

| | | | | | | | | | | | | | |
|---|---|---|---|---|---|---|---|---|---|---|---|---|---|
| Matting Agent | 8 | 8 | 8 | 8 | 8 | 8 | 8 | 8 | 8 | 8 | 8 | 8 | 8 |
| Smoothing Agent | 30 | 30 | 30 | 30 | 30 | 30 | 30 | 30 | 30 | 30 | 30 | 30 | 30 |
| Fluorine-containing Compound | 8 | 8 | 8 | 8 | 8 | 8 | 8 | 8 | 8 | 8 | 8 | 8 | 8 |
| Hydrophilic Compound | 5 | 5 | 5 | 5 | 5 | 5 | 5 | 5 | 5 | 5 | 5 | 5 | 5 |
| Thickener | 9 | 9 | 9 | 9 | 9 | 9 | 9 | 9 | 9 | 9 | 9 | 9 | 9 |
| Cross-Linking Agent | 3 | 3 | 3 | 3 | 3 | 3 | 3 | 3 | 3 | 3 | 3 | 3 | 3 |
| Reaction Catalyst | | | | | | | | | | | | | |

| | | | | | | | | | | | | | |
|---|---|---|---|---|---|---|---|---|---|---|---|---|---|
| Total | 100 | 100 | 100 | 100 | 100 | 100 | 100 | 100 | 100 | 93 | 98 | 98 | 98 |
| Gas-induced Discoloration | 4 | 3 | 3 | 2 | 3 | 3 | 3 | 3 | 2 | 1 | 1 | 1 | 1 |

DOP: Degree of Polymerization,
DOS: Degree of Saponification,
MW: Molecular Weight

As is apparent from a comparison between Examples 1 to 24 and Comparative Example 1 presented in Tables 1 and 2, in the case where the surface treatment agent containing the (A) resin capable of forming a resin layer on a surface of a leather base material and the (B) compound having two or more active hydrogens per molecule was used to form the surface treatment layer made of the surface treatment agent on the surface of the leather base material (Examples 1 to 24), the discoloration of the leather surface due to the NOx gas was reduced as compared with the case where the surface treatment agent not containing the (B) compound having two or more active hydrogens per molecule was used (Comparative Example 1), so that it was confirmed that yellowing of the leather surface due to a NOx gas can be suppressed. In addition, it was found that, in the case where the compound having three or more hydroxyl groups per molecule was blended as the (B) compound (Examples 1 to 18 and 20 to 23), yellowing of the leather surface can be more suppressed than in the case where the propanediol (Example 19) or the polyimine (Example 24) was blended as the (B) compound. It was also found that, in the case where the polyglycerin having five or more hydroxyl groups per molecule was blended as the (B) compound (Examples 1 to 16), yellowing of the leather surface can be even more suppressed than in the case where the diglycerin (Example 17), the glycerin (Example 18), or the polyvinyl alcohol (Examples 20 to 23) was blended as the (B) compound. It was further found that, in the case where the polyglycerin having six or more hydroxyl groups per molecule was blended as the (B) compound (Examples 1 to 10 and 12 to 15), yellowing of the leather surface can be particularly suppressed than in the case where the triglycerin was blended as the (B) compound (Example 16).

On the other hand, as is clear from the comparison between Comparative Examples 2 to 4 and Comparative Example 1 presented in Table 2, in the case where the surface treatment agent containing the compound having one active hydrogen per molecule was used (Comparative Examples 2 to 4), the surface of the obtained leather was yellowed as much as the surface of the leather in the case where the surface treatment agent not containing the (B) compound having two or more active hydrogens per molecule was used (Comparative Example 1). In other words, it was found that, even if a surface treatment layer is formed of a surface treatment agent containing a compound having one active hydrogen per molecule, it is difficult to suppress yellowing of the leather surface.

From the above results, it was confirmed that in order to suppress yellowing of a surface of a leather base material due to NOx, it is effective to form a surface treatment layer on the surface of the leather base material by using a blend of the (A) resin capable of forming a resin layer on a surface of a leather base material and the (B) compound having two or more active hydrogens per molecule (preferably a compound having three or more hydroxyl groups per molecule, more preferably a polyglycerin having five or more hydroxyl groups per molecule, and even more preferably a polyglycerin having six or more hydroxyl groups per molecule).

Therefore, it was confirmed that, for example, in a cushioning composite material in which a flexible polyurethane foam is laminated with any of various leathers by the flame lamination method, the surface treatment agent for leather of the present invention is capable of suppressing yellowing of the leather surface due to a NOx gas contained in a gas generated from the flexible polyurethane foam during burning with flame or the like, and that, even when laminated to a flexible polyurethane foam by the flame lamination method, in a leather of the present invention, yellowing of a surface is difficult to occur during burning with flame or the like.

### INDUSTRIAL APPLICABILITY

As described above, according to the present invention, it is possible to suppress yellowing of a leather surface. Therefore, since yellowing of the surface is difficult to occur, leather products formed of leathers of the present invention can be used as stable and high-quality leather products, and can be suitably used in various industrial fields such as automobiles, furniture, clothing, bags, shoes, sacks, and groceries. In particular, a cushioning composite material in which a flexible polyurethane foam is laminated with a leather of the present invention by the flame lamination method can be used as a leather product with excellent surface quality, because yellowing of the leather surface due to a NOx gas contained in a gas generated from the flexible polyurethane foam during burning in the flame lamination method is suppressed.

1. A surface treatment agent for leather comprising:
an (A) resin capable of forming a resin layer on a surface of a leather base material; and
a (B) compound having two or more active hydrogens per molecule.

2. The surface treatment agent for leather according to claim 1, wherein the (B) compound having two or more active hydrogens per molecule is a compound having three or more hydroxyl groups per molecule.

3. The surface treatment agent for leather according to claim 1, wherein the (B) compound having two or more active hydrogens per molecule is a glycerin-based compound.

4. The surface treatment agent for leather according to claim 1, wherein the (A) resin capable of forming a resin layer on a surface of a leather base material is at least one selected from the group consisting of polyurethane-based resins and acrylic resins.

5. A leather comprising:
a leather base material; and
a surface treatment layer formed on a surface of the leather base material, the surface treatment layer formed of the surface treatment agent for leather according to claim 1.

6. A cushioning composite material comprising:
a flexible polyurethane foam; and
the leather according to claim 5, laminated to a surface of the flexible polyurethane foam.

7. The surface treatment agent for leather according to claim 1, wherein the (B) compound having two or more active hydrogens per molecule is at least one compound selected from the group consisting of aliphatic polyols having four or more hydroxyl groups per molecule, polyhydric phenols having two or more hydroxyl groups per molecule, and compounds having two or more amino groups and/or imino groups per molecule.

8. The surface treatment agent for leather according to claim 1, wherein the (B) compound having two or more active hydrogens per molecule is at least one compound selected from the group consisting of aliphatic polyols having four or more hydroxyl groups per molecule which are intermolecular dehydration products of alkane triols, aliphatic polyols having four or more hydroxyl groups per molecule which are intramolecular or intermolecular dehydration products of alkane polyols, and compounds having two or more amino groups per molecule.

9. A leather comprising:
a leather base material; and
a surface treatment layer formed on a surface of the leather base material, the surface treatment layer formed of the surface treatment agent for leather according to claim 2.

10. A leather comprising:
a leather base material; and
a surface treatment layer formed on a surface of the leather base material, the surface treatment layer formed of the surface treatment agent for leather according to claim 3.

11. A leather comprising:
a leather base material; and
a surface treatment layer formed on a surface of the leather base material, the surface treatment layer formed of the surface treatment agent for leather according to claim 4.

12. A leather comprising:
a leather base material; and
a surface treatment layer formed on a surface of the leather base material, the surface treatment layer formed of the surface treatment agent for leather according to claim 7.

13. A leather comprising:
a leather base material; and
a surface treatment layer formed on a surface of the leather base material, the surface treatment layer formed of the surface treatment agent for leather according to claim 8.

14. A cushioning composite material comprising:
a flexible polyurethane foam; and
the leather according to claim 9, laminated to a surface of the flexible polyurethane foam.

15. A cushioning composite material comprising:
a flexible polyurethane foam; and
the leather according to claim 10, laminated to a surface of the flexible polyurethane foam.

16. A cushioning composite material comprising:
a flexible polyurethane foam; and
the leather according to claim 11, laminated to a surface of the flexible polyurethane foam.

17. A cushioning composite material comprising:
a flexible polyurethane foam; and
the leather according to claim 12, laminated to a surface of the flexible polyurethane foam.

18. A cushioning composite material comprising:
a flexible polyurethane foam; and
the leather according to claim 13, laminated to a surface of the flexible polyurethane foam.
